(19) United States
(12) Patent Application Publication
(10) Pub. No.: US 2002/0090542 A1
(43) Pub. Date: Jul. 11, 2002

(54) Composite basic element and its seal for fuel cell and manufacturing process for the assembly

(75) Inventors: Renaut Mosdale, Claix (FR); Didier Marsacq, Grenoble (FR); Sylvie Escribano, Grenoble (FR)

Correspondence Address: PEARNE & GORDON LLP, 526 SUPERIOR AVENUE EAST, SUITE 1200, CLEVELAND, OH, 44114-1484, US

(73) Assignee: Commissariat A L'Energie Atomique

(21) Appl. No.: 10/027,373

(22) Filed: Dec. 21, 2001

(30) Foreign Application Priority Data
Dec. 29, 2000 (FR) 0017280

(51) Int. Cl. H01M 2/08; B05D 5/12; H01M 8/02

(52) U.S. Cl. 429/35; 427/115

(57) ABSTRACT

The manufacturing process can be used to obtain a basic element combining an electrolytic layer (11), two electrodes (12) and a seal (13) made of a single piece that can easily be integrated and is manageable.

It consists of using a porous matrix (10) in which the electrolytic layer (11) is deposited first except at the periphery, followed by a single seal (13) around the periphery with a thickness that exceeds the thickness of the electrolytic layer (11). The two electrodes (12) are then deposited at the middle of the seal (13) on the two sides of the electrolytic layer (11).

Application to all types of fuel cells.

### FIELD OF THE INVENTION

The invention relates to fuel cells using a solid or liquid electrolyte. The applications concerned are local or decentralized production of energy, land, space or sea transport. The scale of powers in these fuel cells is very broad, since it ranges from mobile and portable units producing a few milliwatts, to static installations producing a power of several kilowatts, for example cells using acid or basic solid polymer electrolytes.

### PROBLEM ART AND THE PROBLEM THAT ARISES

Fuel cells are electrochemical cells composed of a stack of electricity generating stages. Each of them comprises an anode and a cathode placed on each side of an electrolytic element. A different reagent, namely a fuel and an oxidant, arrives on each outside surface of the two electrodes. These reagents react chemically through the electrolytic element, such that it is possible to pickup an electrical voltage at the electrode terminals.

A great deal of interest has been shown in fuel cells in recent years for very many applications, for various different sizes. For example, there are high power stationary installations such as solid oxide fuel cells generating a power of several megawatts. This type of fuel cell must be continuously cooled to dissipate the residual heat. Other applications are batteries for small portable equipment with a power not exceeding a few watts, such as fuel cells with ion exchanger membrane and direct methanol fuel cells for which cooling is not necessary.

When designing all these different types of fuel cells, it is desirable to produce “clean” energy, in other words energy with little or no emission of toxic gases or greenhouse effect gases, while having an acceptable efficiency. Technologies using polymer electrolytes combine the advantages of fuel cells operating at low temperature, for example fast start up, and solid systems, namely that there are no liquid leaks and no counter-ion migration (in fact, only the ion transporting the current is mobile). Basic elements of fuel cells are composed of an assembly including an electrolytic membrane surrounded by two electrodes 2, namely an anode and a cathode, that are in contact with this membrane. The electrolytic membrane may be composed either of a solid material, for example a polymer or ceramic material, or a liquid such as concentrated acid or base or molten salts. If liquid electrolytes are used, they are usually contained within a small thickness of material forming a porous matrix, and the two electrodes are placed facing this matrix. Solid materials are specifically in the form of a film for polymers, or a solid deposit for ceramic materials.

FIG. 1 shows an example of a basic element according to prior art. It contains a membrane or thin electrolytic layer 1 sandwiched between two electrodes 2. These electrodes are surrounded by a seal 3 around their periphery, also placed on each side of the surface of the electrolytic layer 1. This type of seal 3 is used to seal the area in which each electrode is located, against the electrolytic layer. In other words, it is found that the fuel or the oxidant in contact with one of the two electrodes 2 cannot pass through the electrolytic layer 1 and cannot escape from this assembly towards the outside, due to the seals 3, considering that this basic element is located between two polar plates in direct contact with the seals 3. In general, the seals are flat or are 0-rings. They may also be composed of seal materials deposited directly on the electrolytic membrane 1.

This technique provides excellent guarantees about the global leak tightness of the complete stack of basic elements, but causes irrational use of the electrolytic layer 1 of each basic element. At the moment, the electrolytic layer 1 is one of the most important components of the different types of fuel cells, in the same way as bipolar plates of each stage and the catalyst.

One purpose of the invention is to reduce the manufacturing cost of the cell by reducing the manufacturing cost and therefore the marketing cost of each basic element. Research about the nature of the electrolytic polymer has already been made, but other methods could be considered, such as increasing the performance of cells, namely reducing the resistance of the electrolytic membrane, or optimizing its use. The latter method was chosen to achieve this objective, as suggested by the manufacturing process and the basic element according to the invention.

Furthermore, it is found that problems can arise in positioning the seals on each side of the basic element comprising the electrodes and the electrolytic layer, when considering large production series. Therefore another purpose of the invention is to overcome this disadvantage.

Several objectives follow on from these two purposes, namely to reduce the cost of the electrolytic layer, to rationalize its use, to reduce the total number of parts in the stack forming the fuel cell and to create a shape for the fuel cell to facilitate its integration into a variety of environments.

### SUMMARY OF THE INVENTION

Consequently, a first main objective of the invention is a basic composite element comprising an electrolytic layer surrounded by two electrodes and its seal, for a fuel cell, comprising mainly:

an electrolytic layer,

two plate-shaped electrodes adjacent to each side to the electrolytic layer; and

a seal placed around the electrolytic layer and the electrodes to make the assembly composed of this electrolytic layer and the two electrodes leak tight.

According to the invention, the element comprises a plate made of a woven material composed of a basic support for the three elements mentioned above, a specific thickness corresponding to the thickness of the electrolytic layer and in which this electrolytic layer is deposited except at the periphery, the seal being placed only in and on the periphery of this plate made of a woven material, around the electrolytic layer.

It is very advantageous if the thickness of the seal is greater than the thickness of the electrolytic layer and the plate made of a woven material, the overthickness corresponding to at least the thickness of the electrodes deposited on each side of the electrolytic layer.

In its preferred embodiment, the plate made of a woven material is a porous matrix.

Teflon or glass could be considered to make this porous matrix.

A second main objective of the invention is a process for making a basic composite element composed of an electrolytic layer, two electrodes and the seal for a fuel cell, the electrolytic layer being composed of an electrolytic deposit in a porous matrix. The process consists of:

cutting out a porous matrix to the general shape of the basic composite element and its seal;

depositing an ionic conductor in the entire thickness of the porous matrix except at the periphery to form the electrolytic layer; and

depositing a seal material around the periphery of the porous matrix with an overthickness on each side of the porous matrix corresponding to at least the thickness of each electrode.

The process is advantageously used with the subsequent deposit of a material forming electrodes on each side of the porous matrix facing the ionic conducting deposit forming the electrolytic layer without exceeding the thickness of the seal.

### LIST OF FIGURES

The invention and its various technical characteristics will be better understood after reading the following description with the following attached figures:

FIG. 1, that is an exploded front and top sectional view of a basic element of the fuel cell according to prior art,

FIG. 2, that is an exploded front and top sectional view of a porous matrix used in the basic fuel cell element according to the invention,

FIG. 3, that is an exploded front and top sectional view of the same porous matrix as in FIG. 2 in which the electrolytic layer has been deposited,

FIG. 4, that is an exploded sectional view of the same porous layer as in FIG. 3, in which the seal for the basic element has been deposited; and

FIG. 5, that is an exploded sectional view of the assembly shown in FIG. 4 together with two electrodes.

### DETAILED DESCRIPTION OF AN EMBODIMENT OF THE INVENTION

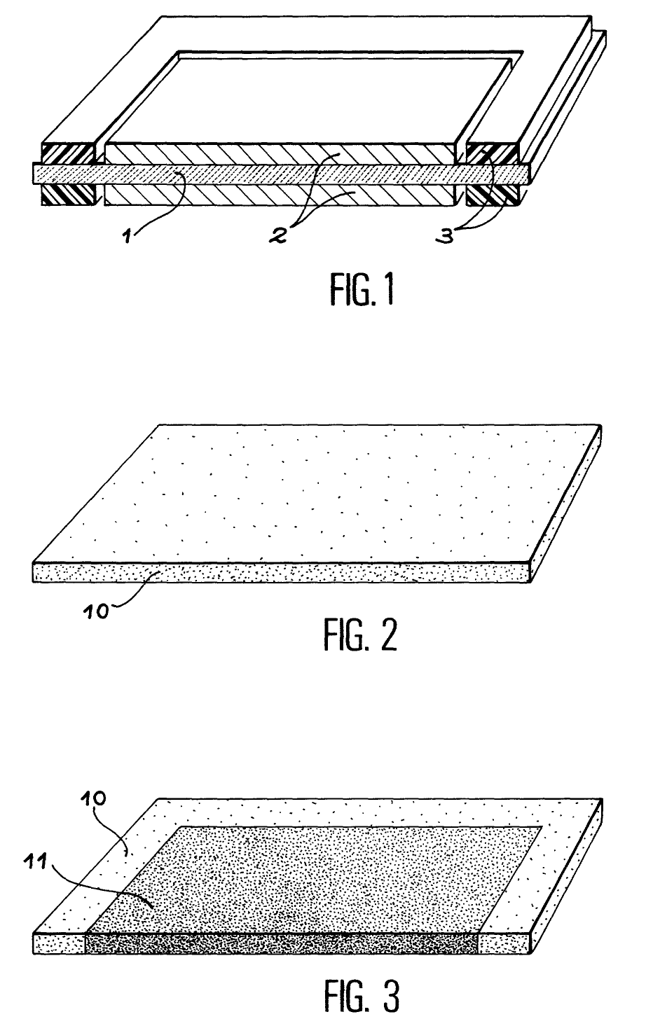

With reference to FIG. 2, the first step in manufacturing the basic element according to the invention consists of selecting the plate made of a woven material that will form the support structure for the entire basic element.

It is planned particularly to use porous glass or porous teflon to form a porous matrix 10. The shape of this porous matrix defines the general shape of the basic element and consequently the shape of the cross-section of the fuel cell. Chemical cleaning or processing may be applied depending on the state of this porous matrix 10 and the material from which it is made. Furthermore, the nature and the weave of this porous matrix may be varied as a function of the types of electrolytic material and the seal types injected into the porous matrix 10. However, note that this weave must be sufficiently porous, for example it must have an open “matt”, woven or sintered type of porosity.

With reference to FIG. 3, the porous matrix 10 is always shown in the same manner. On the other hand, the dark area which is at the center but which occupies the entire thickness of the porous matrix 10, represents an ionic conducting deposit forming the electrolytic layer 11. This shape, that leaves the periphery of the two large surfaces of the porous matrix 10 free, is obtained by gluing masks at this location so that the electrolytic material is not effectively deposited at this location.

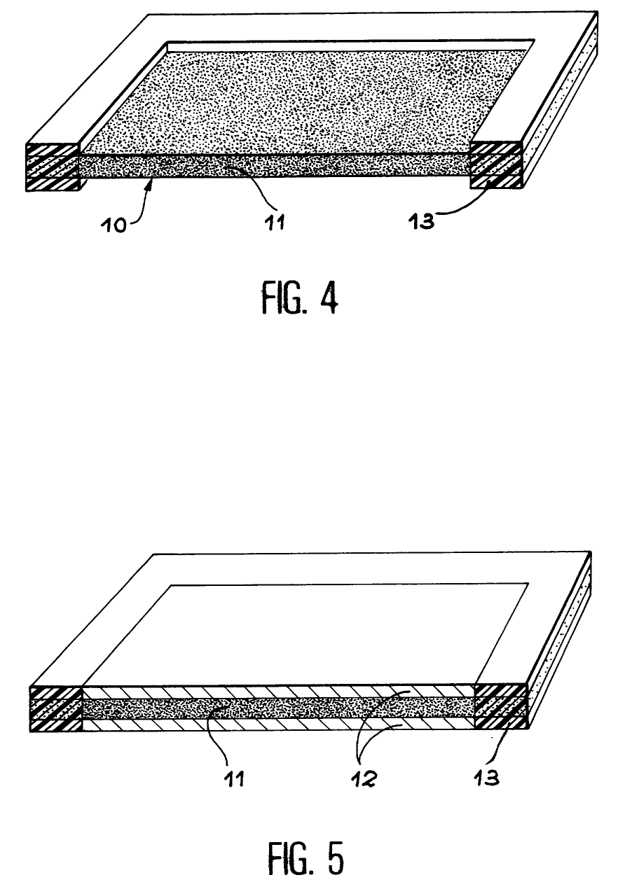

With reference to FIG. 4, the next phase consists of depositing the seal material inside and on the peripheral part of the porous matrix 10 that has not been filled with electrolytic material.

The material used to make the seal 13 thus formed must be chemically inert and electronically and tonically insulating. The thickness of the seal must be greater than the thickness of the electrolytic layer 11 so that the polar plates between which the basic element will be sandwiched can apply pressure to it. The shape of these plates should be adapted to the thickness of the seal and the thickness of the electrodes that will be located in the middle of the seal. Thus, the leak tightness of the electrolytic part will be achieved when tightening the stack.

Finally, with reference to FIG. 5, the last phase of the process according to the invention consists of depositing the electrodes 12 in contact with the two main surfaces of the porous matrix 10, facing the electrolytic layer 11. The thickness of the electrodes 12 must not exceed the overthickness of the seal 13 such that, when the different stages in the fuel cell are tightened, each seal 13 can be compressed very slightly. This deposit is possible using a material such as a platinum coated carbon powder, that is fixed on the porous matrix 10 already saturated with the electrolytic layer 11.

### ADVANTAGES OF THE INVENTION

One of the main advantages of this process for making this type of basic element, compared with processes mentioned in the first pages of this patent application, is its simplicity. It only involves operations to deposit the material in suspension or in solution in the porous matrix and the only accessory that it uses is the masks.

This technique can be used for high or low temperature type fuel cell stacks, in other words cooled or uncooled fuel cells, depending on the characteristics of the materials chosen to make up the different elements.

This technology can be used to produce cells or basic elements of fuel cells with new geometries that may be more or less complex and adapted to the size to be occupied by the fuel cell.

The electrolytic layer may be obtained directly without needing to use expensive techniques such as extrusion or casting of the material.

The use of masks and polymerization of materials deposited directly in the weave guarantees perfect positioning of the different elements, particularly for the seal. The basic element thus formed and comprising the electrodes, the electrolytic layer and seal no longer forms a single piece, that can easily be integrated into the stack of the fuel cell. Furthermore, since the materials are deposited in a compact manner within the thickness of the porous matrix, the assembly forms a homogenous single piece object impermeable to gas.

Finally, the process according to the invention can be used to limit the quantities of electrolytic polymer present in the fuel cell thus formed.

1. Basic composite element of the electrolytic layer/electrodes type and its seal for a fuel cell comprising:
an electrolytic layer (11),
two plate shaped electrodes (12) fixed on each side of the electrolytic layer (11); and
a seal (13) placed around the electrolytic layer (11) and the electrodes (12) to make the electrolytic layer (11) and the two electrodes (12) assembly leak tight,
characterized in that it comprises a plate made of a woven material comprising a basic support for the electrolytic layer (11), the two electrodes (12) and the seal (13), and having a determined thickness corresponding to the thickness of the electrolytic layer (11), and in which the electrolytic layer (11) is deposited except around the periphery, the seal (13) being deposited only in and on the said periphery of the plate made of a woven material, around the electrolytic layer (11).

2. Basic composite element for a fuel cell according to claim 1, characterized in that the thickness of the seal (13) is greater than the thickness of the electrolytic layer (11) and the plate made of a woven material, the overthickness corresponding to at least the overthickness of the electrodes (12) deposited on each side of the electrolytic layer (11).

3. Basic composite element for a fuel cell according to claim 1, characterized in that the plate made of a woven material is a porous matrix (10).

4. Basic composite element for a fuel cell according to claim 1, characterized in that the porous matrix (10) forming the plate made of a woven material is made of teflon.

5. Basic composite element for a fuel cell according to claim 3, characterized in that the porous matrix (10) forming the plate made of a woven material is made of glass.

6. Process for production of a basic composite element consisting of an electrolytic layer (1), two electrodes (2) and its seal (3) for a fuel cell, the electrolytic layer (11) being composed of an electrolytic deposit in a porous matrix (10), this process consisting of:
cutting out a porous matrix (10) to the general shape of the basic composite element and its seal (13);
depositing an ionic conductor in the porous matrix (10) over its entire thickness except at the periphery, to form the electrolytic layer (11); and
depositing a seal material (13) at the periphery of the porous matrix (10) with an overthickness on each side of the porous matrix (10) corresponding to at least the thickness of each electrode (2).

7. Process according to claim 6, characterized in that it is complemented by the subsequent deposit of a material forming electrodes (12) on each side of the porous matrix (10) facing the deposit of the ionic conductor forming the electrolytic layer (11) without exceeding the thickness of the seal (13).
